(19) United States
(12) Patent Application Publication
(10) Pub. No.: US 2015/0030871 A1
(43) Pub. Date: Jan. 29, 2015

(54) FUNCTIONALLY GRADED THERMAL BARRIER COATING SYSTEM

(71) Applicants: Gerald J. Bruck, Oviedo, FL (US); Ahmed Kamel, Orlando, FL (US)

(72) Inventors: Gerald J. Bruck, Oviedo, FL (US); Ahmed Kamel, Orlando, FL (US)

(21) Appl. No.: 14/016,501

(22) Filed: Sep. 3, 2013

Related U.S. Application Data
(63) Continuation-in-part of application No. 13/951,542, filed on Jul. 26, 2013.

(51) Int. Cl. C23C 28/04; F01D 25/00; B23K 26/34; C23C 24/08; B23K 26/00

(52) U.S. Cl. CPC C23C 28/042; C23C 24/08; B23K 26/0081; B23K 26/345; F01D 25/005
USPC 428/547; 427/554; 118/641

(57) ABSTRACT

A functionally graded thermal barrier coating (30) formed as a plurality of layers (34, 36 . . . 44, 46) of materials deposited by a powder deposition process wherein the composition of the various layers changes across a thickness of the coating. A composition gradient may exist within a single layer (58) due to the buoyancy of ceramic particles (62) within a melt pool (56) of bond coat material (64). The powder deposition process includes powdered flux material (20) which melts to form a protective layer of slag (28) during the deposition process.

This application is a continuation-in-part of co-pending U.S. patent application Ser. No. 13/951,542, filed 26 Jul. 2013 (attorney docket 2013P03164US) which is incorporated by reference herein.

### FIELD OF THE INVENTION

The invention relates generally to the field of materials technology, and more particularly to thermally insulated metallic alloys as may be used in gas turbine engine applications, and to methods of applying thermal barrier coatings to metallic alloys.

### BACKGROUND OF THE INVENTION

Ceramic thermal barrier coating systems are used on gas turbine engine hot gas path components to protect the underlying metal alloy substrate from combustion gas temperatures that exceed the safe operating temperature of the alloy. A typical thermal barrier coating system may include a bond coat, such as an MCrAlY material, deposited onto the substrate alloy and a ceramic topcoat, such as yttria stabilized zirconia, deposited onto the bond coat. Bond coat and ceramic materials are often deposited by a thermal spray process, such as High Velocity Oxy-Fuel (HVOF) or Air Plasma Spray (APS).

Functionally graded materials are characterized by a gradual change in composition over a volume. Such materials avoid the disadvantages sometimes associated with abrupt material changes, such as the distinct change in material properties at the material interfaces in a thermal barrier coating system. A metal- ceramic gradient material is described in United States Patent No. 6,322,897 as being formed by sintering a packed bed of powder having a graded composition across the bed.

### BRIEF DESCRIPTION OF THE DRAWINGS

The invention is explained in the following description in view of the drawings that show:

FIG. 1 illustrates the deposition of a coating onto a substrate by a powder deposition process using a laser to melt alloy particles under a bed of flux material.

FIG. 2 illustrates a functionally graded thermal barrier coating system deposited as a plurality of layers of material with varying compositions.

FIG. 3 illustrates a powder deposition process forming a bond coat layer having a graded concentration of ceramic material.

### DETAILED DESCRIPTION OF THE INVENTION

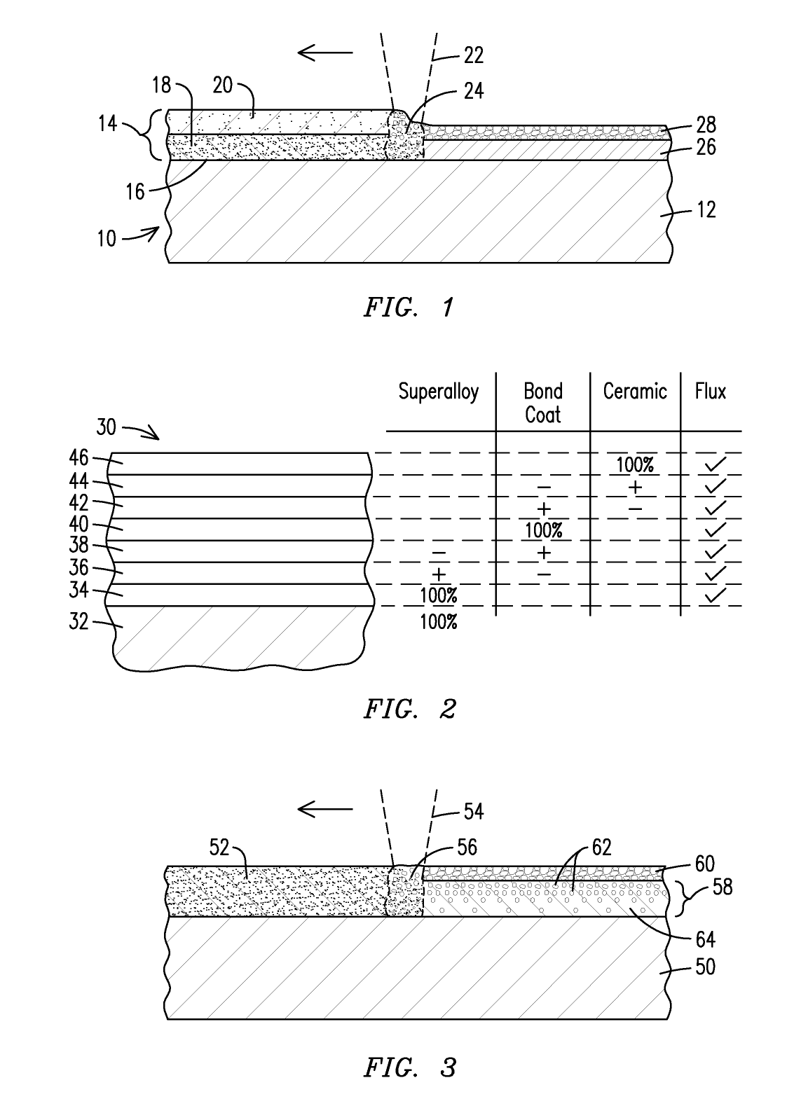

FIG. 1 is a partial cross-sectional view of a gas turbine component 10 having a substrate 12 to which it is desired to add a protective coating. A layer of powder 14 is deposited onto a surface 16 of the substrate 12. The layer of powder 14 includes particles of a metal alloy 18, such as an MCrAlY bond coat material, and particles of a flux material 20. The flux material 20 is applied to provide cleansing and atmospheric protection functions during a subsequent melting step. The particles of metal alloy 18 may be covered by the particles of flux material 20, as illustrated. In other embodiments the particles of metal alloy and particles of flux material may be mixed together and pre-positioned as a single layer, or they may be applied by directing a spray of particles toward the surface during the melting step. Still an additional alternate is that flux and metal material may be provided as composite particles and either pre-placed or fed. The powder 14 is exposed to an energy beam 22, such as a laser beam, to form a melt 24. The melt 24 will segregate and solidify into a coating 26 of the metal alloy 26 covered by a layer of slag 28 on the surface 16. The slag 28 can then be removed to reveal the coating of bond coat material 26 on the substrate 12.

The inventors have successfully deposited CoNiCrAlY bond coat material using the method described above with alloy powder thicknesses of 1-4 mm under flux powder thicknesses of 2-5 mm, making crack free deposits from 0.7-3 mm thick. Bond coat material powder layers up to 1 mm thick may preferably be covered by flux material layers at least 3 mm thick, and bond coat material powder layers 1-4 mm thick may preferably be covered by flux material layers at least 5 mm thick. Various laser types may be utilized including ytterbium fiber, slab, diode, neodynemium YAG, and carbon dioxide. Fluxes of oxides, fluorides and carbonates may be utilized from the broad family of submerged arc welding, flux cored arc welding, electro slag welding and shielded metal arc welding materials, or variants thereof. Power levels may be typically 2 kilowatts but may vary depending on area to be processed, processing speed, depth of deposition and related variables.

After the layer of slag 28 is removed, a further layer of material can be applied by the steps illustrated in FIG. 1 in order to build the deposited coating to a desired thickness in a plurality of layers. One such process is illustrated in FIG. 2 where a thermal barrier coating 30 is deposited on a superalloy substrate 32 in a plurality of layers, 34, 36, 38, 40, 42, 44, 46. Particles of differing material types may be used when depositing the various layers, with a ratio of the types of materials changing between layers to produce a functional gradient in the coating 30. FIG. 2 also includes a table showing relative proportions of superalloy particles, bond coat particles and ceramic particles in each respective layer. The column titled “Flux” indicates that each layer is deposited using a powder deposition process as described with regard to FIG. 1, such as laser melting or laser sintering.

Layer 34 includes 100% superalloy particles. This type of layer may be useful for repairing cracks or irregularities in the substrate 32.

Layer 36 includes both superalloy material and bond coat material, but has a higher content of superalloy material than of bond coat material (i.e. lean bond coat, rich superalloy).

Layer 38 also includes both superalloy and bond coat materials, but it includes relatively more bond coat material (i.e. rich bond coat) than superalloy material and more bond coat material than in layer 36.

Layer 40 includes only bond coat material.

Layer 42 includes both bond coat material and a lesser amount of ceramic insulating material.

Layer 44 includes both bond coat material and ceramic material, but with more ceramic material than in layer 42.

Layer 46 includes only ceramic insulating material.

Layers 34, 36, 38, 40, 42, 44, 46 are exemplary of a functionally graded thermal barrier coating systems formed by powder deposition of a plurality of layers of material with the composition of the layers varying across the thickness of the coating. Different combinations of these layers or other types of layers may be included in other embodiments. For example, in one embodiment the coating may lack layer 32 and/or layer 40. Multiple steps of more gradually changing composition ratios may be used in other embodiments. Some layers may include superalloy, bond coat and ceramic materials. Layers may be of equal or varying thicknesses. Multiple compositions of superalloy, bond coat and/or ceramic materials may be used in a single coating system.

Because the flux material used in the powder deposition process described herein provides improved protection against cracking, it is possible to deposit a layer of bond coating material of up to 3 mm or more. When such a layer is formed with some concentration of ceramic particles included in the powder layer, the natural buoyancy of the ceramic material within the melted bond coat material will tend to drive the ceramic particles toward the upward surface of the melt. By controlling the process parameters, it is now possible to produce a functionally graded concentration of ceramic particles in a bond coat layer. One such process is illustrated in FIG. 3 where a substrate 50 is covered by a layer of powder 52 including a mixture of bond coat material, ceramic material and flux material. An energy beam 54 is rastered over the powder 52 to form a melt 56 which segregates into a coating 58 and an overlying layer of slag 60. The coating 58 includes particles of the ceramic material 62 encased in a matrix of bond coat material 64. Because ceramic materials typically have a density (e.g. less than 6 g/cm³) that is less than metallic alloys (e.g. greater than 8 g/cm³), the natural buoyancy of the ceramic particles within the melt 56 will be effective to provide a gradient in concentration of the ceramic material 62 through the thickness of the coating 58. The coating 58 may include a top region that is close to pure ceramic and a bottom region that is close to pure bond coat. Such a graded layer 58 may be formed as one of a plurality of different layers of a thermal barrier coating system, such as being deposited over a bond coat material layer and/or under a ceramic material layer, or it may function alone in that capacity. Such graded layer 58 may also include superalloy material in some embodiments.

While various embodiments of the present invention have been shown and described herein, it will be obvious that such embodiments are provided by way of example only. Numerous variations, changes and substitutions may be made without departing from the invention herein. The term substrate includes any material having a surface onto which a coating is applied, and it may include a superalloy component or such a component already having one or more layers of any coating material that will subsequently receive another coating. Accordingly, it is intended that the invention be limited only by the spirit and scope of the appended claims.

The invention claimed is:

1. A method comprising:
depositing powder comprising particles of a bond coat material and particles of a flux material onto a substrate;
melting the powder with an energy beam to form a layer of melted bond coat material covered by a layer of slag on the substrate;
allowing the melted bond coat material to cool and solidify under the layer of slag to form a coating on the substrate; and
removing the layer of slag.

2. The method of claim 1, further comprising depositing the powder as a layer of the bond coat material particles on the substrate and a layer of the flux material particles on the layer of the bond coat material particles.

3. The method of claim 2, further comprising depositing the layer of bond coat material particles to be no more than 1 mm thick and the layer of flux material particles to be at least 3 mm thick.

4. The method of claim 2, further comprising depositing the layer of bond coat material particles to be 1-4 mm thick and the layer of flux material particles to be at least 5 mm thick.

5. The method of claim 1, further comprising:
repeating the steps of claim 1 a plurality of times to build the coating to a desired thickness in a plurality of layers;
including particles of an additional material in the powder for at least some of the layers of the coating; and
changing a ratio of the particles of the additional material to particles of the bond coat material between at least some of the layers to produce a functional gradient in the coating.

6. The method of claim 5, wherein the additional material comprises a superalloy material, and the ratio of particles of the superalloy material to particles of the bond coat material decreases from one of the layers to a subsequent layer.

7. The method of claim 5, wherein the additional material comprises a ceramic material, and the ratio of particles of the ceramic material to particles of the bond coat material increases from one of the layers to a subsequent layer.

8. The method of claim 1, further comprising:
repeating the steps of claim 1 a plurality of times to build the coating to a desired thickness in a plurality of layers;
including particles of a ceramic material in the powder for at least one of the layers of the coating; and
depositing the at least one layer to have a thickness wherein buoyancy of the ceramic material within the melted bond coat material is effective to produce a functional gradient in concentration of the ceramic material through a thickness of the at least one layer.

9. An apparatus comprising:
a superalloy substrate;
a thermal barrier coating disposed on the substrate, the thermal barrier coating further comprising:
a first region relatively more proximate the substrate comprising a bond coat material but no ceramic material; and
a second region relatively more remote from the substrate comprising the bond coat material and a gradient concentration of a ceramic material, wherein the gradient concentration of the ceramic material relative to the bond coat material increases in a thickness direction away from the substrate.

10. The apparatus of claim 9, wherein the first region further comprises a gradient concentration of a superalloy material and the bond coat material, and wherein the gradient concentration of the superalloy material relative to the bond coat material decreases in the thickness direction away from the substrate.

11. The apparatus of claim 10, wherein the first region comprises a layer of only bond coat material with no ceramic material and no superalloy material.

12. The apparatus of claim 10, wherein the first region comprises no layer of only bond coat material.

13. The apparatus of claim 9, wherein the gradient concentration in the second region is formed by buoyancy of particles of the ceramic material within melted bond coat material during deposition of the second region by a powder deposition process.

14. The apparatus of claim 9, wherein the thermal barrier coating further comprises a plurality of layers of material deposited by successive iterations of a powder deposition process, wherein the powder deposited in successive layers has differing proportions of material types to produce the first and second regions.

15. The apparatus of claim 14, wherein the thermal barrier coating further comprises:
a layer comprising bond coat material plus ceramic material; and
a layer comprising only ceramic material.

16. The apparatus of claim 15, wherein the thermal barrier coating further comprises a layer comprising bond coat material and superalloy material.

17. The apparatus of claim 15, wherein the thermal barrier coating comprises a layer comprising only bond coat material.

18. An apparatus comprising:
a superalloy substrate;
a coating disposed on the substrate;
the coating comprising a plurality of layers of material, the layers changing in proportion of superalloy material to bond coat material from a relatively higher concentration of superalloy material in a first layer to a relatively higher concentration of bond coat material in a second layer more remote from the substrate than the first layer.

19. The apparatus of claim 18, further comprising the layers changing in proportion of bond coat material to ceramic material from a relatively higher concentration of bond coat material in a third layer to a relatively higher concentration of ceramic material in a fourth layer more remote from the substrate than the third layer.

20. The apparatus of claim 19, further comprising a layer comprising only bond coat material disposed between the second and third layers.
